(19) United States
(12) Patent Application Publication
(10) Pub. No.: US 2012/0287676 A1
(43) Pub. Date: Nov. 15, 2012

(54) LIGHT GUIDE PLATE STRUCTURE AND METHOD OF FABRICATING THE SAME

(76) Inventor: Ko-Ju Chen, Taoyuan (TW)

(21) Appl. No.: 13/225,498

(22) Filed: Sep. 5, 2011

(30) Foreign Application Priority Data
May 11, 2011 (TW) 100116475

(51) Int. Cl. F21V 8/00; H05H 1/24; B05D 5/06

(52) U.S. Cl. 362/627; 427/162; 427/535

(57) ABSTRACT

The present invention relates to a light guide plate structure including a light guide layer and at least a light-barrier line. The light-barrier line includes an ink and is disposed within the light guide layer for blocking a light from being transmitted all over the light guide layer, and the light-barrier line is employed to allow the light to be just transmitted in separated regions within the light guide layer or to prevent light leakage. The present invention also relates to fabrication of the aforesaid light guide plate structure, in which, a surface modification is performed on the light guide layer, and a modified surface of the light guide layer is printed with an ink to allow the ink to permeate or corrode the light guide layer to form a light-barrier line within the light guide layer.

### BACKGROUND OF THE INVENTION

1. Field of the Invention

The present invention relates to a light guide plate structure, and more particularly, to a light guide plate structure related to keypads.

2. Description of the Prior Art

Light sources and light guide plates are required in structures of keypad for providing light to dark regions and making the keypad recognizable. Regional illumination has been proposed for saving energy or for illuminating different colors in each region. The conventional light guide plate for regional illumination generally forms a multi-layered structure or includes a plurality of holes formed by a punching process. However, the light-barrier performance of the conventional light guide plate for regional illumination is not ideal, and the related processes are complicated. The problems such as low yield and high cost for the conventional light guide plate are still to be solved. The conventional structures of the light guide plate are listed below.

A light guide plate is disclosed in Japan Pat. No. 2010-073317. The light guide plate comprises a plurality of closed ring light absorbing parts on the base material for regional illumination with light sources for edge lighting. The ring light absorbing parts are disposed on the base material by adhesive materials.

A light guide plate is disclosed in Japan Pat. No. 2010-153361. Strip-like recess groove parts are formed on the light guide plate, and the dark colored light absorption parts are formed in the recess groove parts by a die-cutting process to prevent light from being transmitted in the light guide plate and realize various illuminations in different regions. The thickness of the light guide plate has to be thicker than a substantial thickness or a base material such as a dome-sheet has to be disposed under the light guide plate, because the recess grooves have to be formed in the light guide plate and the predetermined light absorption parts have to be filled into the recess grooves. The light guide plates in the different regions are separated form each other.

A light guide plate is disclosed in Japan Pat. No. 2010-212123. Slopes are formed on one face by cutting the light guide plate, and dark-colored light absorbing parts are formed by imprinting an ink on the slopes and the notches. The light guide plates in the different regions are separated from each other. A base material such as a dome-sheet has to be disposed under the light guide plate after cutting the light guide plate, and then the light absorbing parts may be filled into the light guide plate.

A method of preventing light leakage on edges of a light guide plate is disclosed in Japan Pat. No. 2010-212173. A dark tape for light leakage prevention is arranged on an outer circumferential end surface of the light guide plate, and extra light leakage from the light guide plate can be prevented.

Therefore, a more convenient and inexpensive method of fabricating the light guide plate for regional illumination is still demanded.

### SUMMARY OF THE INVENTION

It is one of the objectives of the present invention to provide a light guide plate structure and a method of fabricating the same for realizing regional light-guiding or preventing light leakage.

In an aspect of the present invention, a light guide plate structure according to the present invention includes a light guide layer and at least a light-barrier line. The light-barrier line comprises an ink and is disposed within the light guide layer for blocking a light from being transmitted all over the light guide layer, and the light-barrier line is employed to allow the light to be just transmitted in separated regions within the light guide layer or to prevent light leakage.

In another aspect of the present invention, a method of fabricating a light guide plate structure according to the present invention includes the following steps. A light guide layer is provided. A surface modification is performed on the light guide layer. An ink is printed on a modified surface of the light guide layer to allow the ink to permeate or corrode the light guide layer to form a light-barrier line within the light guide layer.

In the present invention, the ink such as a black light-barrier ink is printed on the light guide layer and the ink permeates or corrodes the light guide layer to form a light-barrier line within the light guide layer. The light-barrier line may be used to block the light and define separated regions for light guiding, and regional illumination or light leakage prevention may then be achieved. The light guide plate structure with the regional illumination function may be applied to backlight modules for lowering power consumption of the light source such as light-emitting diode (LED) light source. The standby time of the batteries may therefore be enhanced, and the competitiveness and the additional value of the products may be enhanced too. Additionally, only one single layer of the light guide layer is required in the present invention, the fabrication process may be simple, and the manufacturing cost may become lowered.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a top view of a light guide plate structure according to an embodiment of the present invention.

FIG. 2 is a schematic diagram illustrating an enlarged cross-sectional view of a light guide plate structure according to an embodiment of the present invention.

FIG. 3 is a schematic diagram illustrating a cross-sectional view of a light guide plate structure according to another embodiment of the present invention.

FIG. 4 is a schematic diagram illustrating a top view of a light guide plate structure according to another embodiment of the present invention.

FIG. 5 is a schematic diagram illustrating a cross-sectional view of a light guide plate structure according to another embodiment of the present invention.

FIG. 6 is a flowchart describing a method of fabricating a light guide plate structure according to an embodiment of the present invention.

### DETAILED DESCRIPTION

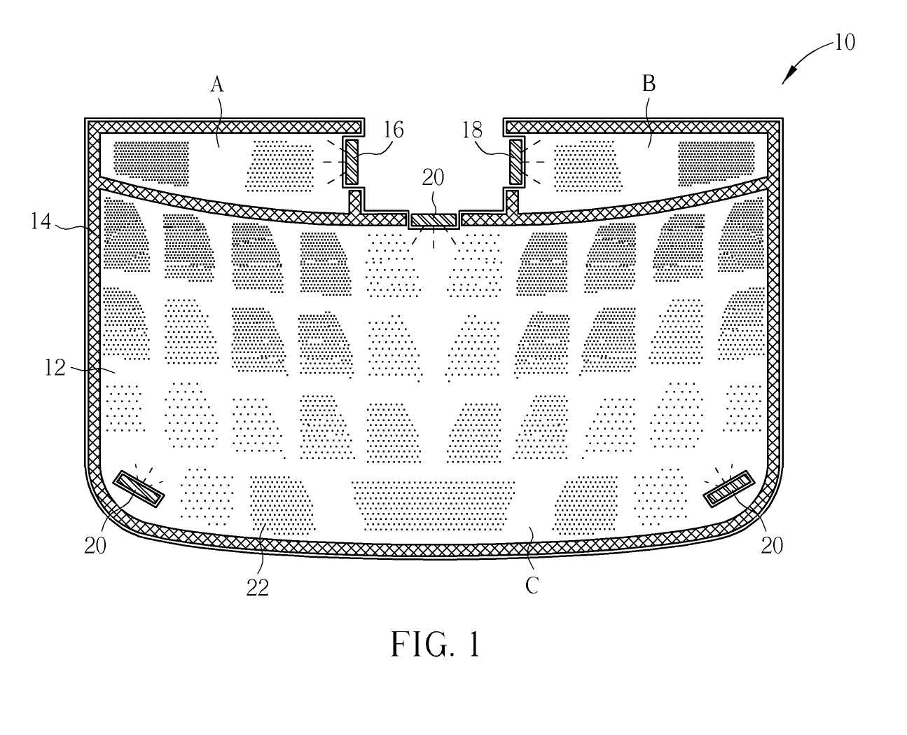

FIG. 1 is a schematic diagram illustrating a top view of a light guide plate structure according to an embodiment of the present invention. The light guide plate structure 10 includes a light guide layer 12 and a light-barrier line 14. The light-barrier line 14 is disposed within the light guide layer 12 for blocking a light from being transmitted all over the light guide layer 12, and the light-barrier line 14 may be employed to allow the light to be just transmitted in separated regions within the light guide layer 12. Therefore, a single-layered light guide plate with a regional illumination function may be obtained. As shown in FIG. 1, the light-barrier line 14 may be used to block the light from being transmitted all over the light guide layer 12, and the light guide plate structure 10 is divided into a region A, a region B, and a region C by the light-barrier line 14. For example, light from a light source 16 may be blocked by the light-barrier line 14 and only transmitted in the region A; light from a light source 18 may be blocked by the light-barrier line 14 and only transmitted in the region B; and light from a light source 20 may be blocked by the light-barrier line 14 and only transmitted in the region C. The power consumptions of each of the light sources may then be reduced because the light from each of the light sources may be concentrated within each of the regions, the luminance of each region may be enhanced or the required light source may be reduced. The light-barrier line 14 around the light guide layer 12 may be used as a light-shielding structure for preventing the light from being emitted to the environment, and the light-barrier lines 14 may be a structure for preventing light leakage in the light guide plate.

As shown in FIG. 1, a plurality of microstructures 12 for changing paths of light within the light guide layer 12 are disposed on a surface of the light guide layer 12.

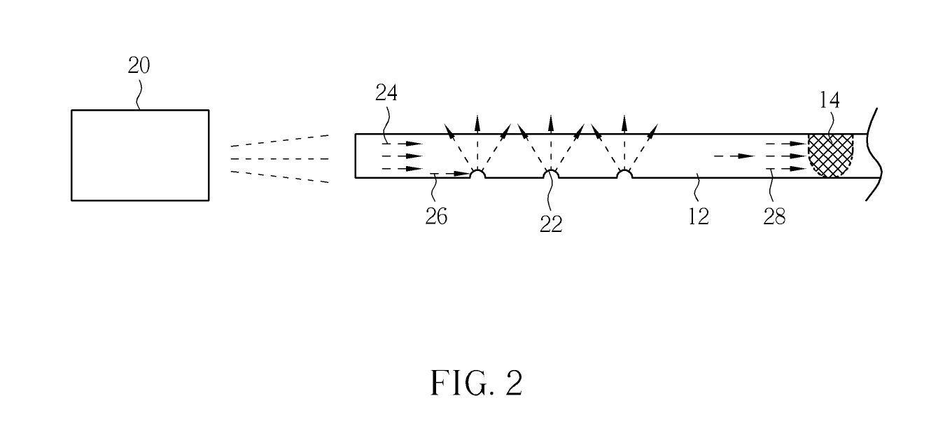

FIG. 2 is a schematic diagram illustrating an enlarged cross-sectional view of a light guide plate structure according to an embodiment of the present invention. The light from the light source 20 may enter the light guide layer 12 and become light 24. The light 24 may include light 26 and light 28. Paths of the light 26 may be changed by the microstructure 22, and the light 26 may be emitted from an upper surface of the light guide layer 12. The light 28 may be transmitted to the light-barrier line 14 and blocked by the light-barrier line 14.

Materials of the light guide layer may include materials which may be permeated or corroded by the ink. For example, the materials of the light guide layer may include silicone, thermoplastic polyurethane (TPU), or other flexible light guide materials. A thickness of the light guide layer may be modified as needed and is not limited for any purposes. For example, the thickness of the light guide layer may be about 0.125 mm for applications such as thin keypad structure, but not limited thereto.

The light-barrier line includes an ink disposed within the light guide layer for blocking a light from being transmitted all over the light guide layer. Preferably a light-barrier ratio (also called a light-shielding ratio, opposite to a light transmitting ratio) of the light-barrier line is higher than 80%. The ink may have a property of absorbing light or a property of reflecting light. The ink may include dark-colored inks such as black inks and deep blue inks, but not limited thereto. Different inks may be chosen according to different materials to be adhered to, such as the light guide layer. For instance, a black ink which is made of polyurethane (PU) may be introduced for the light guide layer made of TPU. Osmotic regents may also be mixed into the ink for improving the permeation condition of the ink. The light guide layer may be a single-layered structure because the ink is printed on the light guide layer and permeates or corrodes the light guide layer. The light-barrier line may be formed from any sides of the light guide layer. A range of a width of the light-barrier line is not limited specifically, and a depth of the light-barrier line is not limited to be equal to the thickness of the light guide layer. An appropriate depth of the light-barrier line with a light-barrier ratio higher than 80% is preferred. As shown in FIG. 2, the light-barrier line 14 is formed from a side of the light guide layer 12, and the microstructures 22 are formed from another side of the light guide layer 12, but the present invention is not limited to this.

In other embodiments of the present invention, the shape of the microstructure may include a convex shape or a concave shape, such as a sphere, a hemisphere, a cone, a tetragonal pyramid, or a taper with a 90 degree angle. The microstructures may be formed from each side of the light guide layer. The microstructures may be disposed regionally for forming a plurality of microstructure zones. Each of the microstructure zones is disposed corresponding to each of the predetermined positions of the keypad. The luminance of the light from the light source may become different at different positions of the light guide layer after entering the light guide layer. Therefore, a density of the microstructures corresponding to the position with higher luminance is preferably designed to be lower than a density of the microstructures corresponding to the position with lower luminance.

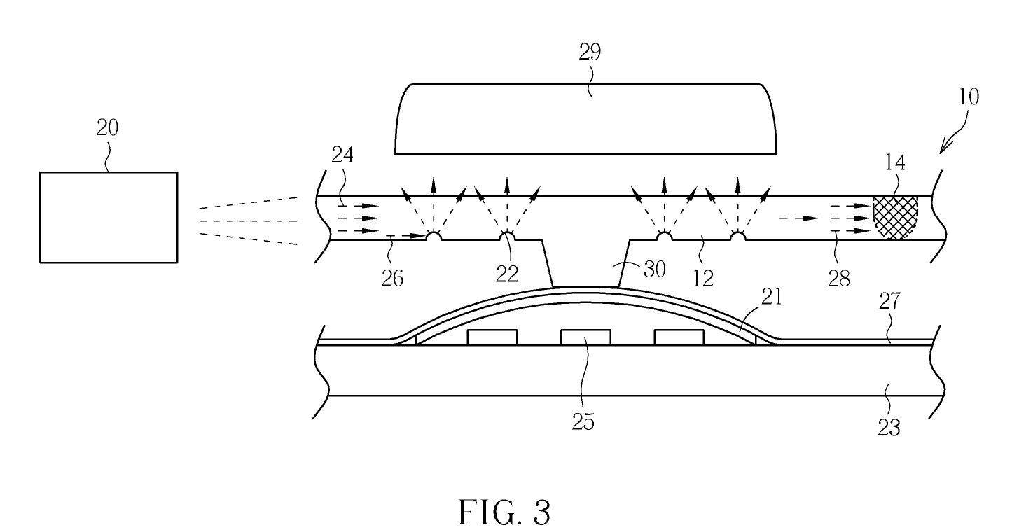

FIG. 3 is a schematic diagram illustrating a cross-sectional view of a light guide plate structure in a keypad structure according to another embodiment of the present invention. As shown in FIG. 3, the light guide layer 12 includes at least a plunger 30. The plunger 30 may be employed for transmitting pressing force from a user to a metal dome 21. The metal dome 21 may then contact circuits 25 on a printed circuit board 23, and the metal dome 21 may be electrically connected to the printed circuit board 23. The metal dome 21 may be fixed on the printed circuit board 23 via a film dome 27. A key cap structure 29 is disposed above the light guide layer 12, and the key cap structure 29 is disposed corresponding to the plunger 30.

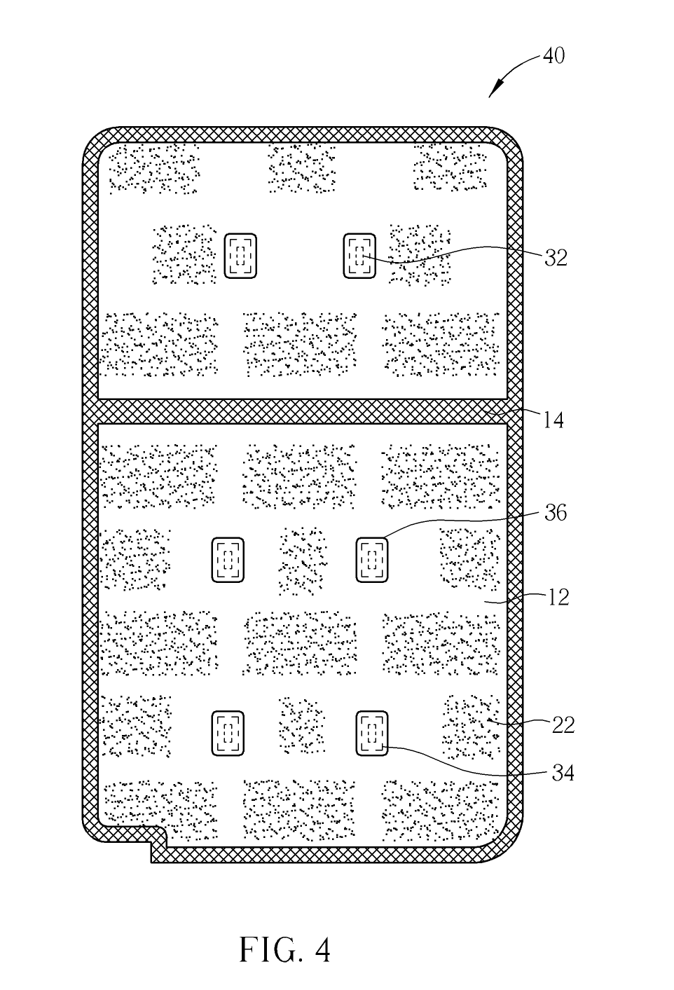

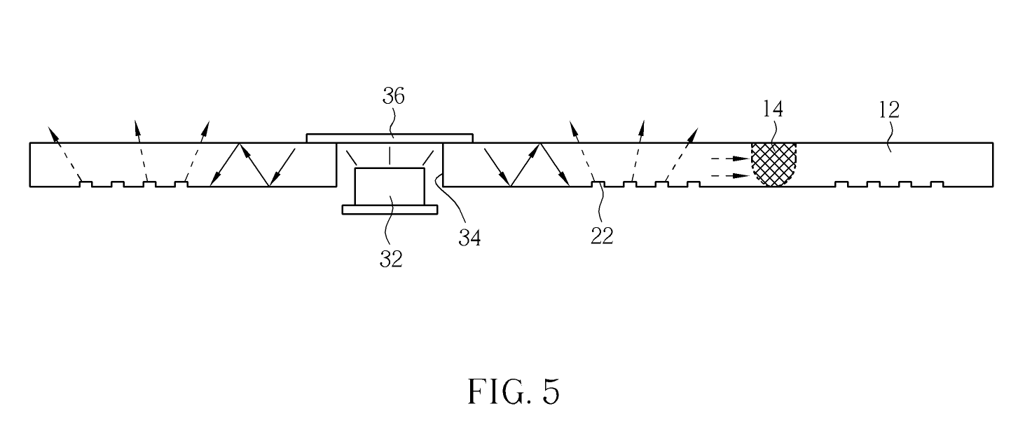

FIGS. 1-3 are schematic diagrams illustrating a condition of the light guide plate structure applied with light sources for edge lighting according to the present invention. The light guide plate structure of the present invention may also be applied with light sources for bottom lighting, as with the condition shown in FIG. 4 and FIG. 5 for example. A light guide plate structure 40 includes the light guide layer 12 and the light-barrier line 14 described above. As shown in FIG. 4 and FIG. 5, the light-barrier line 14 surrounds the light guide layer 12 and divides the light guide layer 12 into two light guide regions. The light guide layer 12 may also include a plurality of the microstructures 22 described above. Light from a light source 32 such as a LED light source may enter the light guide layer 12 from an opening 34 of the light guide layer 12. The opening 34 may be covered with a light shielding sheet 36 for blocking light.

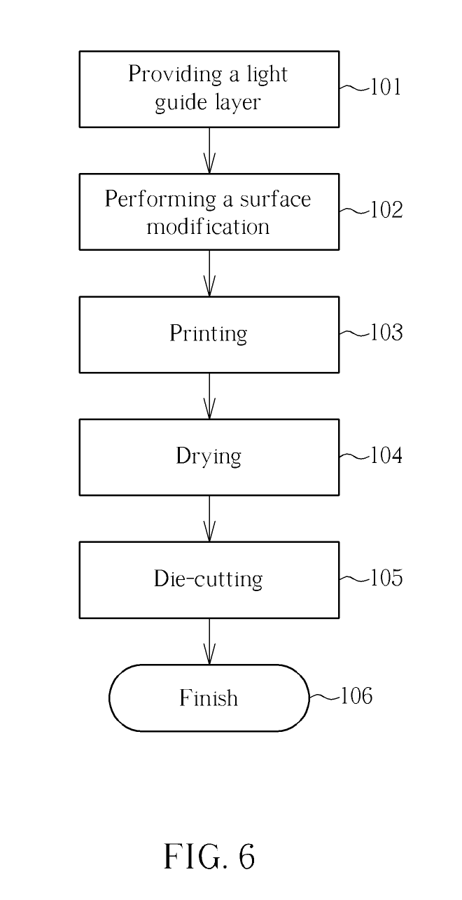

FIG. 6 is a flowchart describing a method of fabricating a light guide plate structure according to an embodiment of the present invention. Please refer to FIG. 6 and FIG. 2. First, in step 101, a light guide layer 12 is provided. Details of the light guide layer 12 have been described above. In step 102, a surface modification is performed on the light guide layer 12. The surface modification is employed for allowing materials of the light-barrier line 14, which is going to be subsequently formed within the light guide layer 12, to permeated or corrode the light guide layer 12 more easily. The surface modification may be employed for enhancing the adhesion of surfaces of the light guide layer by using mediums for example; and the surface modification may also be employed for roughening the surface of the light guide layer, and the surface modification may include, for example, corona treatment, UV plasma treatment, or plasma treatment.

In step 103, an ink is printed on a modified surface of the light guide layer 12. Because the surface of the light guide layer 12 is modified by the surface modification, the ink may then permeate or corrode the light guide layer 12 to form a light-barrier line 14 within the light guide layer 12 more easily. A permeation ratio is in direct proportion with a light-barrier ratio. The light-barrier ratio increases as the permeation ratio increases. A printing process for printing the ink may include a screen printing process or other appropriate printing processes. The advantage of screen printing is that a pressing force on the light guide layer 12 may be used to prompt the ink to permeate the light guide layer 12. Subsequently, in step 104, the ink may be dried as needed. In step 105, a die-cutting process may be used to form a single light guide plate and openings as needed. In step 106, procedures of fabricating the light guide plate are finished, and a light guide plate structure is obtained.

In addition, the microstructures 22 may be formed before or after the step 103 where the ink is printed on the light guide layer 12. The microstructures 22 may be formed by laser treatment or formed simultaneously with the light guide layer 12 by molding. The microstructures 22 may be formed on a surface of the light guide layer 12 with printing, or the microstructures 22 may be formed on another surface of the light guide layer 12 without printing. The plunger 30 and the light guide layer 12 may be further formed monolithically.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light guide plate structure, comprising:
a light guide layer; and
at least one light-barrier line, wherein the light-barrier line comprises an ink and is disposed within the light guide layer for blocking a light from being transmitted all over the light guide layer, and the light-barrier line is employed to allow the light to be just transmitted in separated regions within the light guide layer or to prevent light leakage.

2. The light guide plate structure of claim 1, wherein the ink has a property of absorbing light or a property of reflecting light.

3. The light guide plate structure of claim 1, wherein the ink permeates the light guide layer.

4. The light guide plate structure of claim 1, wherein the ink corrodes the light guide layer.

5. The light guide plate structure of claim 1, wherein the light guide layer comprises a plurality of microstructures for changing paths of light within the light guide layer.

6. The light guide plate structure of claim 1, wherein the light guide layer comprises at least one plunger for transmitting pressing force from a user to a metal dome of a key.

7. A method of fabricating a light guide plate structure, comprising:
providing a light guide layer;
performing a surface modification on the light guide layer; and
printing an ink on a modified surface of the light guide layer to allow the ink to permeate the light guide layer to form a light-barrier line within the light guide layer.

8. The method of fabricating the light guide plate structure of claim 7, wherein the surface modification comprises surface roughening.

9. The method of fabricating the light guide plate structure of claim 7, wherein the surface modification comprises corona treatment, UV plasma treatment, or plasma treatment.

10. The method of fabricating the light guide plate structure of claim 7, further comprising die-cutting the light guide layer for forming the light guide plate structure.

11. The method of fabricating the light guide plate structure of claim 7, further comprising forming a microstructure in the light guide layer.

12. The method of fabricating the light guide plate structure of claim 7, further comprising drying the ink after the ink permeates or corrodes the light guide layer to form the light-barrier line within the light guide layer.

13. The method of fabricating the light guide plate structure of claim 7, wherein a printing process for printing the ink includes a screen printing process.

14. A method of fabricating a light guide plate structure, comprising:
providing a light guide layer;
performing a surface modification on the light guide layer; and
printing an ink on a modified surface of the light guide layer to allow the ink to corrode the light guide layer to form a light-barrier line within the light guide layer.

15. The method of fabricating the light guide plate structure of claim 14, wherein the surface modification comprises surface roughening.

16. The method of fabricating the light guide plate structure of claim 14, wherein the surface modification comprises corona treatment, UV plasma treatment, or plasma treatment.

17. The method of fabricating the light guide plate structure of claim 14, further comprising die-cutting the light guide layer for forming the light guide plate structure.

18. The method of fabricating the light guide plate structure of claim 14, further comprising forming a microstructure in the light guide layer.

19. The method of fabricating the light guide plate structure of claim 14, further comprising drying the ink after the ink permeates or corrodes the light guide layer to form the light-barrier line within the light guide layer.

20. The method of fabricating the light guide plate structure of claim 14, wherein a printing process for printing the ink includes a screen printing process.
